(19) United States
(12) Patent Application Publication
(10) Pub. No.: US 2025/0288487 A1
(43) Pub. Date: Sep. 18, 2025

(54) CLOSED LOOP MECHANICAL SYSTEM WITH PHYSIOLOGICAL FEEDBACK

(71) Applicant: KONINKLIJKE PHILIPS N.V., Eindhoven (NL)

(72) Inventors: SHUJIE CHEN, Bothell, WA (US); DAWN BLILIE JORGENSON, Bothell, WA (US); CONNER DAVID PITTS, Bothell, WA (US); MADISON KATHLEEN GALLAGHER, Bothell, WA (US); CHRISTIAN JAMES RICHARD, Bothell, WA (US)

(21) Appl. No.: 18/860,030

(22) PCT Filed: Apr. 20, 2023
(86) PCT No.: PCT/EP2023/060208

§ 371 Date: Oct. 25, 2024

Related U.S. Application Data
(60) Provisional application No. 63/334,224, filed on Apr. 25, 2022.
(60) Provisional application No. 63/357,178, filed on Jun. 30, 2022.

(51) Int. Cl. A61H 31/00

(52) U.S. Cl. CPC A61H 31/006; A61H 2201/5053; A61H 2230/305

(57) ABSTRACT

Various exemplary embodiments of the present disclosure encompass a physiological monitor for monitoring a physiological parameter of a patient during cardiopulmonary resuscitation (“CPR”) on the patient and a mechanical CPR device having an adjustable configuration for regulating chest compressions on the patient during CPR on the patient. During the CPR on the patient, an exemplary CPR controller controls the adjustable configuration of the mechanical CPR device based on sustaining the physiological parameter monitoring of the patient by the physiological monitor at a baseline physiological parameter level for the patient.

### FIELD OF THE INVENTION

The present disclosure generally relates to a mechanical cardiopulmonary resuscitation (“CPR”) device to perform chest compression during CPR, and more particularly to controlling a mechanical CPR device for achieving a quality CPR.

### BACKGROUND OF THE INVENTION

Currently, chest compression during CPR is typically done (1) by a human responder with no feedback, (2) by a human responder with feedback on the mechanics of the compression (e.g., depth, rate, recoil) and (3) a mechanical CPR device with a fixed configuration and no feedback. These types of chest compression scenarios are less than ideal for achieving CPR quality, thus the field of resuscitation is heavily focused on increasing CPR quality to have a better chance of saving lives.

### SUMMARY OF THE INVENTION

The present disclosure is directed to a mechanical CPR device for performing chest compression during CPR with a physiological parameter monitoring of the CPR quality, which is then fed back in real-time to the mechanical CPR device for adjusting how the CPR is performed, in order to maintain certain physiological parameter(s) at a level set prior to CPR or adjusted during CPR.

Exemplary embodiments in accordance with the present disclosure can be embodied as:
(1) a CPR system including a mechanical CPR device having an adjustable configuration for regulating chest compressions on the patient during CPR on the patient;
(2) a CPR controller to control an adjustable configuration of the mechanical CPR device for regulating chest compressions on a patient during CPR on the patient; and
(3) a CPR method for regulating chest compressions on a patient during CPR on the patient by a mechanical CPR device having an adjustable configuration.

Various CPR system exemplary embodiments of the present disclosure encompass a physiological monitor for monitoring a physiological parameter of a patient during CPR on the patient, and a mechanical CPR device having an adjustable configuration for regulating chest compressions on the patient during CPR on the patient. Various CPR system exemplary embodiments of the present disclosure further encompass a CPR controller for controlling the adjustable configuration of the mechanical CPR device based on sustaining a physiological parameter monitoring of the patient by the physiological sensor at a baseline physiological parameter level for the patient.

Various CPR controller exemplary embodiments of the present disclosure encompass a non-transitory machine-readable storage medium encoded with instructions for execution by one or more processors to control an adjustable configuration of the mechanical CPR device for regulating chest compressions on a patient during CPR on the patient. The exemplary non-transitory machine-readable storage medium includes instructions to (1) input a physiological parameter monitoring of the patient of the patient during CPR of the patient, and (2) control the adjustable configuration of the mechanical CPR device based on sustaining the physiological parameter monitoring of the patient at a baseline physiological parameter level for the patient.

Various exemplary embodiments of CPR methods in accordance with the present disclosure encompass (1) monitoring, by a physiological monitor, a physiological parameter of a patient during CPR on the patient; and controlling, by a CPR controller, an adjustable configuration of a mechanical CPR device based on sustaining a physiological parameter monitoring of the patient by the physiological sensor at a baseline physiological parameter level for the patient.

The foregoing exemplary embodiments and other embodiments of the present disclosure as well as various structures and advantages of the present disclosure will become further apparent to those having ordinary skill in the art from the following detailed description of various embodiments of the present disclosure read in conjunction with the accompanying drawings. The detailed description and drawings are merely illustrative of the present disclosure rather than limiting, the scope of the present disclosure being defined by the appended claims and equivalents thereof.

### BRIEF DESCRIPTION OF THE DRAWINGS

The present disclosure will present in detail the following description of exemplary embodiments with reference to the following figures wherein:

FIG. 1 illustrates an exemplary embodiment of a CPR system in accordance with the present disclosure;

FIG. 2 illustrates an exemplary embodiment of a flowchart representative of a CPR method in accordance with the present disclosure; and

FIG. 3 illustrates an exemplary embodiment of a CPR controller of FIG. 1 in accordance with the present disclosure.

### DETAILED DESCRIPTION OF THE PREFERRED EMBODIMENTS

The present disclosure provides real-time, closed-loop, physiological feedback for controlling a configuration of a mechanical CPR device to increase CPR quality.

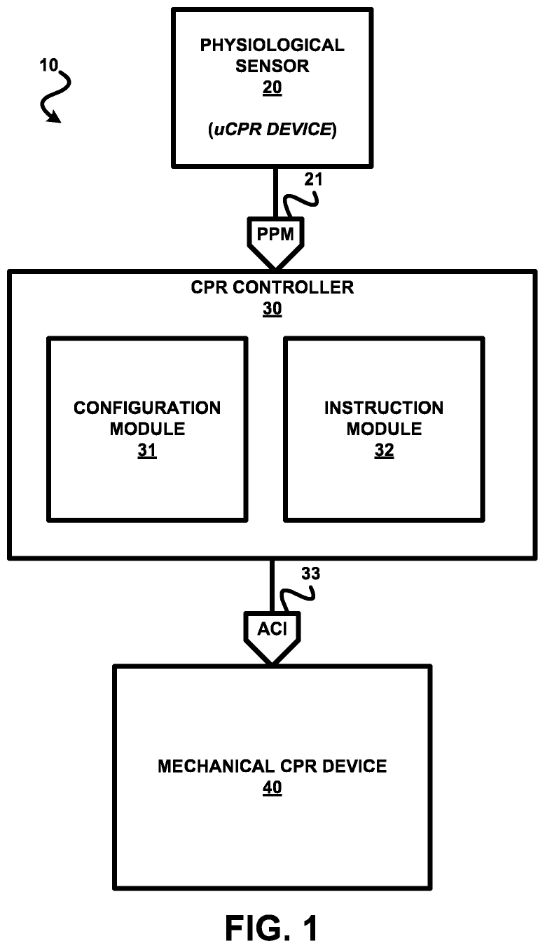

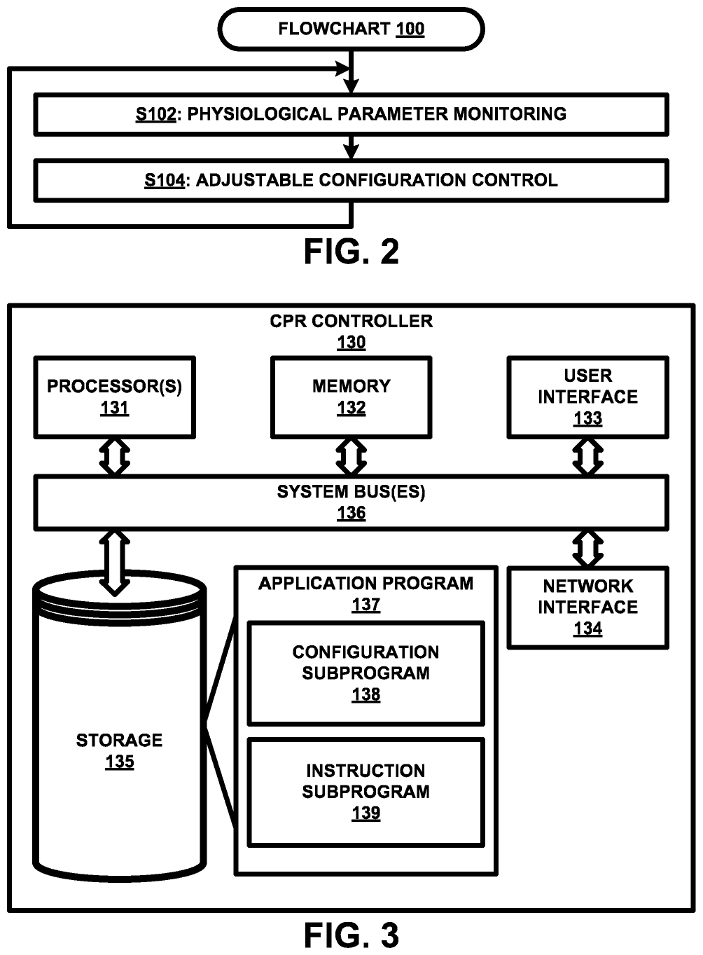

To facilitate an understanding of the present disclosure, the following description of FIGS. 1 and 2 teaches exemplary embodiments of a CPR system and a CPR method in accordance with the present disclosure. From the description of FIGS. 1 and 2, those having ordinary skill in the art of the present disclosure will appreciate how to apply the present disclosure to make and use additional embodiments of CPR systems and CPR methods in accordance with the present disclosure.

Referring to FIG. 1, an exemplary CPR system 10 of the present disclosure employs a physiological monitor 20, a CPR controller 30 and a mechanical CPR device 40.

For purposes of describing and claiming the present disclosure, the term “physiological monitor” broadly encompasses any monitor, as known in the art of the present disclosure or hereinafter conceived, for monitoring one or more physiological parameters (e.g., blood flow/velocity), the term “controller” broadly encompasses any type of controller, as known in the art of the present disclosure or hereinafter conceived, for controlling an operation of other devices, and the term “mechanical CPR device” are terms of the art of the present disclosure.

Non-limiting examples of physiological monitor 20 include an ultrasound CPR device, a pulse oximeter, end tidal CO2 sensor, a blood pressure sensor, a near-infrared spectroscopy, a photoplethysmography sensor, any type of vital sign sensor, and any combination of said devices.

In practice, in accordance with certain exemplary embodiments of the present disclosure, mechanical CPR device 20 has an adjustable configuration for regulating chest compressions on the patient during CPR on the patient (e.g., an adjustable compression depth, an adjustable compression rate and/or an adjustable compression position), and CPR controller 30 controls the adjustable configuration of the mechanical CPR device 40 based on sustaining the physiological parameter monitoring of the patient by the physiological monitor at a baseline physiological parameter level for the patient set prior to CPR or adjusted during CPR.

To this end, for example, the present disclosure functionally links the physiological feedback to the configuration of the mechanical CPR device 40 in accordance with the following exemplary equation [1]:

$${\hat{x}}_{n} = f ( {y}_{n} ; {y}_{1} , {y}_{2} , … , {y}_{n - 1} , {x}_{1} , {x}_{2} , … , {x}_{n - 1} , θ ) \qquad [ 1 ]$$

where \hat{x}ₙ denotes the estimated physiological condition in the n^{th} time slot (the next time slot), yᵢ denotes depth and position with respect to time that is planned for the i^{th} time slot since the start of the proposed system, xi denotes the actual physiological condition (e.g., blood velocity or oxygen in blood) of the i^{th} time slot collected by physiological monitor 20 as feedback, θ denotes the static information of the patient (age, gender, weight, etiology, . . . ). Note that the current time point is the end of the (n−1)^{th} time slot, and the n^{th} time slot is the next one to be planned.

This exemplary model can be converted to a second exemplary model in accordance with the following exemplary equation [2]:

$${y}_{n} = g ( X ; {y}_{1} , {y}_{2} , … , {y}_{n - 1} , {x}_{1} , {x}_{2} , … , {x}_{n - 1} , θ ) \qquad [ 2 ]$$

where X is the needed level of the physiological parameter(s) being monitoring by physiological monitor 20. The value(s) of X can be (pre)set in advance and/or by health care providers in accordance with certain predefined settings and other parameters and/or set and/or adjusted to be different for different patients. Given the historical configurations, the historical physiological feedback, and the patient's static information, this exemplary model will generate yₙ as the configuration for the next time slot in order to achieve the needed level of physiological parameter as monitored by physiological monitor 20.

Note that yᵢ should be limited by certain restriction that prevent unnecessary harm to patient, e.g., depth <=8 cm (can be varied per patient).

Exemplary equation [2] is translated to the next-step configuration in depth/position to instructions for the mechanic CPR device 40. This may be expressed as exemplary equation [3]:

$${z}_{n} = h ( {y}_{n} ; {S}_{n - 1} ) \qquad [ 3 ]$$

where yₙ denotes the predicted next-step configuration, Sₙ₋₁ denotes the current state of the mechanical system, and zₙ denotes the next-step mechanical instructions.

In practice, in accordance with certain exemplary embodiments of the present disclosure, the aforementioned prediction model may be constructed in four (4) phases. Exemplary Phase 1 involves a collection and curation of training data set for model g, which is collected during normal use of mechanical CPR device 40 and physiological monitor 20 (no closed loop system) during CPR. Exemplary Phase 2 involves training a regression of the model. Exemplary Phase 3 involves use of the regression model to guide the closed loop system for CPR on human via a clinical information. Exemplary Phase 4 involves a manual review and correction of the method based on the data collected from the clinical information.

FIG. 2 illustrates an exemplary flowchart 100 representative of a CPR method for regulating chest compressions on a patient during CPR on the patient by a mechanical CPR device 40 having an adjustable configuration in accordance exemplary embodiments of the present disclosure. For example, prior to a commencement of the CPR, physiological monitor 20 is attached to the patient, mechanical CPR device 40 is setup on the patient, the static information of the patient and a baseline physiological parameter level are inputted into CPR controller 30. Thereafter the CPR is commenced and flowchart 100 is initiated for sustaining the baseline physiological parameter level set prior to CPR or adjusted during CPR.

Referring to FIGS. 1 and 2, a stage S102 of exemplary flowchart 100 encompasses physiological monitor 20 communicating the physiological parameter monitoring to CPR controller 30, and a stage S104 of flowchart 100 encompasses a configuration module 31 of CPR controller 30 executing exemplary equation [2] to determine a next-step (interval) configuration of mechanical CPR device 40, and an instruction module 32 of CPR controller 30 executing exemplary equation [3] to determine a next-step (interval) instruction to mechanical CPR device 40 to thereby adjust the configuration of mechanical CPR device 40 as needed to sustain the baseline physiological parameter level. More particularly, the next next-step (interval) instruction to mechanical CPR device 40 will not adjust the configuration of mechanical CPR device 40 if the physiological monitoring equates the baseline physiological parameter level, and will the next next-step (interval) instruction to mechanical CPR device 40 will adjust the configuration of mechanical CPR device 40 if the physiological monitoring approximates the baseline physiological parameter level

Exemplary Stages S102 and S104 are executed in a loop until the CPR is completed.

To facilitate a further understanding of the present disclosure, the following description of FIG. 3 teaches an exemplary embodiment of CPR controller in accordance with the present disclosure. From the description of FIG. 3, those having ordinary skill in the art of the present disclosure will appreciate how to apply the present disclosure to make and use additional embodiments of a CPR controller in accordance with the present disclosure.

Referring to FIG. 3, shown is an exemplary embodiment of CPR feedback controller 130 that includes one or more processor(s) 131, memory 132, a user interface 133, a network interface 134, and a storage 135 interconnected via one or more system bus(es) 136.

Each processor 131 can be any hardware device, as known in the art of the present disclosure or hereinafter conceived, capable of executing instructions stored in memory 132 or storage or otherwise processing data. In a non-limiting example, the processor(s) 131 can include a microprocessor, field programmable gate array (FPGA), application-specific integrated circuit (ASIC), or other similar devices.

The memory 132 can include various memories, as known in the art of the present disclosure or hereinafter conceived, including, but not limited to, L1, L2, or L3 cache or system memory. In a non-limiting example, the memory 132 can include static random access memory (SRAM), dynamic RAM (DRAM), flash memory, read only memory (ROM), or other similar memory devices.

The user interface 133 can include one or more devices, as known in the art of the present disclosure or hereinafter conceived, for enabling communication with a user such as an administrator. In a non-limiting example, the user interface can include a command line interface or graphical user interface that can be presented to a remote terminal via the network interface 134.

The network interface 134 can include one or more devices, as known in the art of the present disclosure or hereinafter conceived, for enabling communication other components of a medical device. In a non-limiting example, the network interface 134 can include a network interface card (NIC) configured to communicate according to the Ethernet protocol. Additionally, the network interface 134 may implement a TCP/IP stack for communication according to the TCP/IP protocols. Various alternative or additional hardware or configurations for the network interface 134 will be apparent.

The storage 135 can include one or more machine-readable storage media, as known in the art of the present disclosure or hereinafter conceived, including, but not limited to, read-only memory (ROM), random-access memory (RAM), magnetic disk storage media, optical storage media, flash-memory devices, or similar storage media. In various non-limiting embodiments, the storage 135 can store instructions for execution by the processor(s) 131 or data upon with the processor(s) 131 may operate. For example, the storage 135 may store a base operating system for controlling various basic operations of the hardware.

The storage 135 can also store an application program in the form of executable software/firmware for implementing the various functions of the methods of FIG. 2 as previously described in the present disclosure. In one exemplary embodiment as shown, storage 135 also stores application program 137 including a configuration subprogram 138 and an instruction subprogram 139 for implementing an exemplary embodiment of stage S104 of flowchart 100.

The present disclosure has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

Further, as one having ordinary skill in the art shall appreciate in view of the teachings provided herein, features, elements, components, etc. disclosed and described in the present disclosure/specification and/or depicted in the appended Figures and/or recited in the Claims can be implemented in various combinations of hardware and software, and provide functions which may be combined in a single element or multiple elements. For example, the functions of the various features, elements, components, etc. shown/illustrated/depicted in the Figures and/or recited in the Claims can be provided through the use of dedicated hardware as well as hardware capable of executing software in association with appropriate software. When provided by a processor, the functions can be provided by a single dedicated processor, by a single shared processor, or by a plurality of individual processors, some of which can be shared and/or multiplexed. Moreover, explicit use of the term “processor” or “controller” should not be construed to refer exclusively to hardware capable of executing software, and can implicitly include, without limitation, digital signal processor (“DSP”) hardware, memory (e.g., read only memory (“ROM”) for storing software, random access memory (“RAM”), non-volatile storage, etc.) and virtually any means and/or machine (including hardware, software, firmware, combinations thereof, etc.) which is capable of (and/or configurable) to perform and/or control a process.

Moreover, all statements herein reciting principles, aspects, and exemplary embodiments of the present disclosure, as well as specific examples thereof, are intended to encompass both structural and functional equivalents thereof. Additionally, it is intended that such equivalents include both currently known equivalents as well as equivalents developed in the future (e.g., any elements developed that can perform the same or substantially similar functionality, regardless of structure). Thus, for example, it will be appreciated by one having ordinary skill in the art in view of the teachings provided herein that any block diagrams presented herein can represent conceptual views of illustrative system components and/or circuitry embodying the principles of the invention. Similarly, one having ordinary skill in the art should appreciate in view of the teachings provided herein that any flow charts, flow diagrams and the like can represent various processes which can be substantially represented in computer readable storage media and so executed by a computer, processor or other device with processing capabilities, whether or not such computer or processor is explicitly shown.

Having described preferred and exemplary embodiments of the present disclosure, which embodiments are intended to be illustrative and not limiting, it is noted that modifications and variations can be made by persons having ordinary skill in the art in view of the teachings provided herein, including the appended Figures and claims. It is therefore to be understood that changes can be made in/to the preferred and exemplary embodiments of the present disclosure which are within the scope of the present disclosure and exemplary embodiments disclosed, described and taught herein.

Moreover, it is contemplated that corresponding and/or related systems incorporating and/or implementing the device or such as may be used/implemented in a device in accordance with the present disclosure are also contemplated and considered to be within the scope of the present disclosure. Further, corresponding and/or related method for manufacturing and/or using a device and/or system in accordance with the present disclosure are also contemplated and considered to be within the scope of the present disclosure.

1. A cardiopulmonary resuscitation (“CPR”) system, comprising:
a physiological monitor configured to monitor a physiological parameter of a patient during CPR on the patient;
a mechanical CPR device having an adjustable configuration for regulating chest compressions on the patient during CPR on the patient; and
a CPR controller configured to control the adjustable configuration of the mechanical CPR device based on sustaining a physiological parameter monitoring of the patient by the physiological monitor at a baseline physiological parameter level for the patient.

2. The CPR system of claim 1, wherein the CPR controller being configured to control the adjustable configuration of the mechanical CPR device includes:
the CPR controller configured to communicate a mechanical instruction to the mechanical CPR device, the mechanical instruction being informative of an adjustment of at least one of compression depth, compression rate and a compression position to be executed by the mechanical CPR device.

3. The CPR system of claim 1, wherein the CPR controller being configured to control the adjustable configuration of the mechanical CPR device includes:
the CPR controller configured to intermittently communicate a mechanical instruction to the mechanical CPR device, each mechanical instruction being informative of a next-interval adjustable configuration of the mechanical CPR device derived from a current-interval physiological parameter monitoring of the patient by the physiological monitor.

4. The CPR system of claim 1, wherein the CPR controller being configured to control the adjustable configuration of the mechanical CPR device includes:
the CPR controller is configured to implement a functional linking of the physiological parameter monitoring of the patient by the physiological monitor to the adjustable configuration of the mechanical CPR device.

5. The CPR system of claim 1, wherein the CPR controller being configured to control the adjustable configuration of the mechanical CPR device is a function of at least one of:
historical adjustable configurations of the mechanical CPR device during the CPR of the patient;
historical patient physiological parameter monitoring of the patient by the physiological monitor during the CPR of the patient;
a personalization of the baseline physiological parameter level for the patient; or
static information of the patient.

6. A cardiopulmonary resuscitation (“CPR”) controller, comprising:
a non-transitory machine-readable storage medium encoded with instructions for execution by at least one processor to control an adjustable configuration of the mechanical CPR device for regulating chest compressions on a patient during CPR on the patient, the non-transitory machine-readable storage medium including the instructions to
input a physiological parameter monitoring of the patient by a physiological monitor during CPR of the patient; and
control the adjustable configuration of the mechanical CPR device based on sustaining the physiological parameter monitoring of the patient at a baseline physiological parameter level for the patient.

7. The CPR controller of claim 6, wherein the instructions to control the adjustable configuration of the mechanical CPR device includes instructions to communicate a mechanical instruction to the mechanical CPR device, the mechanical instruction being informative of an adjustment of at least one of a compression depth, a compression rate and a compression position to be executed by the mechanical CPR device.

8. The CPR controller of claim 6, wherein the instructions to control the adjustable configuration of the mechanical CPR device includes instructions to:
intermittently communicate a mechanical instruction to the mechanical CPR device, each mechanical instruction being informative of a next-interval adjustable configuration of the mechanical CPR device derived from a current-interval physiological parameter monitoring of the patient by the physiological monitor.

9. The CPR controller of claim 6, wherein the instructions to control the adjustable configuration of the mechanical CPR device includes instructions to:
implement a functional linking of the physiological parameter monitoring of the patient by the physiological monitor to the adjustable configuration of the mechanical CPR device.

10. The CPR controller of claim 6, wherein the instructions to control the adjustable configuration of the mechanical CPR device are a function of at least one of:
historical adjustable configurations of the mechanical CPR device during the CPR of the patient;
historical patient physiological parameter monitoring of the patient by the physiological monitor during the CPR of the patient;
a personalization of the baseline physiological parameter level for the patient; or
static information of the patient.

11. A cardiopulmonary resuscitation (“CPR”) method for regulating chest compressions on a patient during CPR on the patient by a mechanical CPR device having an adjustable configuration, the CPR method comprising:
monitoring, by a physiological monitor, a physiological parameter of a patient during CPR on the patient; and
controlling, by a CPR controller, the adjustable configuration of the mechanical CPR device based on sustaining a physiological parameter monitoring of the patient by the physiological monitor at a baseline physiological parameter level for the patient.

12. The CPR method of claim 11, wherein the controlling, by the CPR controller, of the adjustable configuration of the mechanical CPR device includes communicating, by the CPR controller, a mechanical instruction to the mechanical CPR device, the mechanical instruction being informative of an adjustment of at least one of a compression depth, a compression rate or a compression position to be executed by the mechanical CPR device.

13. The CPR method of claim 11, wherein the controlling, by the CPR controller, the adjustable configuration of the mechanical CPR device includes:
intermittently communicating, by the CPR controller, a mechanical instruction to the mechanical CPR device, each mechanical instruction being informative of a next-interval adjustable configuration of the mechanical CPR device derived from a current-interval physiological parameter monitoring of the patient by the physiological monitor.

14. The CPR method of claim 11, wherein the controlling, by the CPR controller, the adjustable configuration of the mechanical CPR device includes:
implementing, by the CPR controller, a functional linking of the physiological parameter monitoring of the patient by the physiological monitor to the adjustable configuration of the mechanical CPR device.

15. The CPR method of claim 11, wherein the controlling, by the CPR controller, the adjustable configuration of the mechanical CPR device is a function of at least one of:
historical adjustable configurations of the mechanical CPR device during the CPR of the patient;
historical patient physiological parameter monitoring of the patient by the physiological monitor during the CPR of the patient;
a personalization of the baseline physiological parameter level for the patient; or
static information of the patient.
